(19) United States
(12) Patent Application Publication
(10) Pub. No.: US 2025/0356790 A1
(43) Pub. Date: Nov. 20, 2025

(54) DISPLAY DEVICE

(71) Applicant: Samsung Display Co., LTD., Yongin-si (KR)

(72) Inventors: Jung Eon AN, Yongin-si (KR); Ki Hyun PYUN, Yongin-si (KR)

(21) Appl. No.: 19/069,612

(22) Filed: Mar. 4, 2025

(30) Foreign Application Priority Data
May 16, 2024 (KR) 10-2024-0063868

(51) Int. Cl. G09G 3/20

(52) U.S. Cl. CPC G09G 3/2092; G09G 2300/0452; G09G 2320/0242; G09G 2340/0407

(57) ABSTRACT

A display device includes: a display panel including a plurality of pixels, a scan driver configured to provide a scan signal to the display panel, a data driver configured to provide a data signal corresponding to each of the plurality of pixels to the display panel, a timing controller configured to control driving of the scan driver and the data driver, and a data converter configured to convert image data output from the timing controller to generate the data signal. The data converter is configured to generate the data signal to cause a first sub-pixel, among sub-pixels included in pixels disposed in an edge area of the display panel, to output light in a first frame in a frame group including a plurality of frames and not to output light in a second frame in the frame group.

This application claims priority to Korean Patent Application No. 10-2024-0063868, filed on May 16, 2024, and all the benefits accruing therefrom under 35 U.S.C. § 119, the content of which in its entirety is herein incorporated by reference.

### BACKGROUND

### 1. Field

The disclosure relates to a display device.

### 2. Description of the Related Art

Recently, interest in an information display is increasing. Accordingly, research and development on a display device is continuously being conducted. The display device includes a plurality of pixels connected to a data line and a scan line. The pixel includes a pixel circuit and a light emitting element, and the light emitting element emits light with a predetermined luminance correspondingly to a driving current supplied from a driving transistor through the pixel circuit.

Each pixel may include at least two sub-pixels to display different colors. According to a way sub-pixels are disposed in the pixel, a problem in which a color of the sub-pixels positioned in an edge area of a display panel is visible may occur.

### SUMMARY

An embodiment of the disclosure provides a display device capable of reducing a problem in which a specific color is visible in an edge area of a display panel.

According to an embodiment of the disclosure, a display device includes: a display panel including a plurality of pixels, a scan driver configured to provide a scan signal to the display panel, a data driver configured to provide a data signal corresponding to each of the plurality of pixels to the display panel, a timing controller configured to control driving of the scan driver and the data driver, and a data converter configured to convert image data output from the timing controller to generate the data signal. The data converter converts the image data so that a first sub-pixel, among sub-pixels included in pixels disposed in an edge area of the display panel, outputs light in a first frame in a frame group including a plurality of frames and does not output light in a second frame in the frame group.

In an embodiment, the data converter may generate the data signal causing a second sub-pixel, among the sub-pixels included in the pixels disposed in the edge area, not to output light in the first frame.

In an embodiment, the data converter may generate the data signal causing second sub-pixels to output light in the second frame.

In an embodiment, the first sub-pixel may be the outermost sub-pixel among the sub-pixels included in the pixels disposed in the edge area, and the second sub-pixel may not be the outermost sub-pixel among the sub-pixels included in the pixels disposed in the edge area.

In an embodiment, the data converter may generate a data signal of the first sub-pixel corresponding to the first frame based on a sum of frame data of the first sub-pixel corresponding to each of frames included in the frame group.

In an embodiment, the data converter may generate the data signal of the first sub-pixel by adding a first weight corresponding to the first sub-pixel to the sum of the frame data of the first sub-pixel.

In an embodiment, the first weight may be a real number less than 0.

In an embodiment, the data converter may generate a data signal of the second sub-pixel corresponding to the second frame based on a sum of frame data of the second sub-pixel corresponding to each of frames included in the frame group.

In an embodiment, the data converter may generate the data signal of the second sub-pixel by adding a second weight corresponding to the second sub-pixel to the sum of the frame data of the second sub-pixel.

In an embodiment, the second weight may be a real number greater than 0.

In an embodiment, the data converter may generate the data signal causing a third sub-pixel, among the sub-pixels included in the pixels disposed in the edge area, to output light in a third frame in the frame group.

In an embodiment, the data converter may generate the data signal causing the third sub-pixel not to output light in the first frame and in the second frame, and the first and second sub-pixels not to output light in the third frame.

In an embodiment, the data converter may generate the data signal causing the third sub-pixel not to output light in the first frame, the third sub-pixel to output light in the second frame, the first sub-pixel not to output light, and the second sub-pixel to output light in the third frame.

In an embodiment, the data converter may generate the data signal causing the third sub-pixel not to output light in the first frame, the first and third sub-pixels to output light in the second frame, and the second sub-pixel to output light in the third frame.

In an embodiment, the frame group may include two frames, and the data converter may generate the data signal causing a third sub-pixel, which is not the outermost sub-pixel among the sub-pixels included in the pixels disposed in the edge area, to output light in the second frame and not to output light in the first frame.

In an embodiment, the data converter may include an edge data determiner configured to determine whether the image data corresponds to the edge area and generates a control signal, a weight generator configured to generate a weight used to convert the image data, and a data generator configured to selectively convert the image data based on the weight and the control signal and generates conversion data.

In an embodiment, the data converter may further include a digital-to-analog converter configured to convert the conversion data into the data signal.

In an embodiment, the data converter may further include a data scaler configured to downscale the image data and provide downscaled image data to the data generator.

According to another embodiment of the disclosure, a display device includes a display panel including a plurality of pixels, a scan driver configured to provide a scan signal to the display panel, a data driver configured to provide a data signal corresponding to each of the plurality of pixels to the display panel, and a timing controller configured to control driving of the scan driver and the data driver, and convert image data to generate the data signal. The timing controller generates the data signal causing a first sub-pixel among sub-pixels included in pixels disposed in an edge area of the display panel to output light in a first frame in a frame group including a plurality of frames and not to output light in a second frame in the frame group.

In an embodiment, the timing controller may generate the data signal causing a second sub-pixel, among the sub-pixels included in the pixels disposed in the edge area, not to output light in the first frame and the second sub-pixel to output light in the second frame.

According to a display device according to embodiments of the disclosure, a problem in which a specific color is visible in an edge area of a display panel may be effectively reduced.

### BRIEF DESCRIPTION OF THE DRAWINGS

The above and other features of the disclosure will become more apparent by describing in further detail embodiments thereof with reference to the accompanying drawings, in which:

FIG. 1 is a block diagram illustrating a display device according to an embodiment of the disclosure;

FIG. 2 is a diagram illustrating a disposition of a sub-pixel according to an embodiment;

FIG. 3 is a diagram illustrating a problem in which a specific color is visible in an edge area of a display panel when a sub-pixel is disposed according to a method of FIG. 2;

FIG. 4 is a diagram illustrating a disposition of a sub-pixel according to another embodiment;

FIG. 5 is a diagram illustrating a problem in which a specific color is visible in an edge area of a display panel when the sub-pixel is disposed according to a method of FIG. 4;

FIG. 6 is a block diagram illustrating a display device according to another embodiment of the disclosure;

FIG. 7 is a block diagram illustrating an embodiment of data converter of FIG. 6;

FIG. 8 is a diagram illustrating image data of an edge area input to a data generator;

FIG. 9 is a diagram illustrating an embodiment of conversion data of the edge area output from the data generator;

FIG. 10 is a block diagram illustrating an embodiment of the data generator of FIG. 7;

FIGS. 11A, 11B, and 11C are diagrams illustrating an operation of the data generator of FIG. 10;

FIG. 12 is a block diagram illustrating another embodiment of the data converter of FIG. 6;

FIG. 13 is a diagram illustrating another embodiment of the conversion data of the edge area output from the data converter;

FIG. 14 is a diagram illustrating still another embodiment of the conversion data of the edge area output from the data converter; and

FIG. 15 is a diagram illustrating further still another embodiment of the conversion data of the edge area output from the data converter.

### DETAILED DESCRIPTION

The disclosure may be modified in various manners and have various forms. Therefore, specific embodiments will be illustrated in the drawings and will be described in detail in the specification. However, the disclosure is not intended to be limited to the disclosed specific forms, and the disclosure includes all modifications, equivalents, and substitutions within the spirit and technical scope of the disclosure.

Terms of “first”, “second”, and the like may be used to describe various components, but the components should not be limited by the terms. The terms are used only for the purpose of distinguishing one component from another component. For example, without departing from the scope of the disclosure, a first component may be referred to as a second component, and similarly, a second component may also be referred to as a first component. In the following description, the singular expressions include plural expressions unless the context clearly dictates otherwise.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It should be understood that in the present application, a term of “include”, “have”, or the like is used to specify that there is a feature, a number, a step, an operation, a component, a part, or a combination thereof described in the specification, but does not exclude a possibility of the presence or addition of one or more other features, numbers, steps, operations, components, parts, or combinations thereof in advance.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the invention. In addition, in some embodiments, the block, unit and/or module may be physically combined into more complex blocks, units, and/or modules without departing from the scope of the invention.

Hereinafter, a display device according to an embodiment of the disclosure is described with reference to drawings related to embodiments of the disclosure.

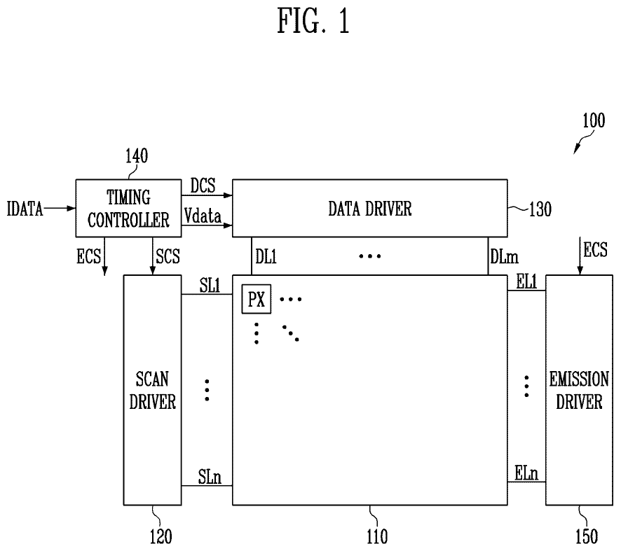

FIG. 1 is a block diagram illustrating a display device according to an embodiment of the disclosure.

The display device 100 may include a display unit 110 (or a display panel), a scan driver 120, a data driver 130, a timing controller 140, and an emission driver 150.

The display unit 110 may include scan lines SL1 to SLn (n is a positive integer), data lines DL1 to DLm (where m is a positive integer), emission control lines EL1 to ELn, and a pixel PX. The pixel PX may include a plurality of sub-pixels, and each of the sub-pixels may be connected to one of the scan lines SL1 to SLn, one of the data lines DL1 to DLm, and one of the emission control lines EL1 to ELn.

For example, a sub-pixel positioned in an i-th row and a j-th column may store or record a data signal (or a data voltage) provided through a j-th data line DLj in response to a scan signal provided through an i-th scan line SLi, and may emit light with a luminance corresponding to the stored data signal in response to an emission control signal provided through an i-th emission control line ELi.

The scan driver 120 may generate a scan signal based on a scan control signal SCS and sequentially provide the scan signal to the scan lines SL1 to SLn. Here, the scan control signal SCS may include a start signal, clock signals, and the like, and may be provided from the timing controller 140. For example, the scan driver 120 may include a shift register that sequentially outputs the scan signal corresponding to the start signal of a pulse form using the clock signals.

The emission driver 150 may generate an emission control signal based on an emission control signal ECS and provide the emission control signal to the emission control lines EL1 to ELn sequentially or simultaneously. For example, the emission driver 150 may include a shift register that sequentially outputs the emission control signal corresponding to an emission start signal of a pulse form using emission clock signals.

The timing controller 140 may receive input image data IDATA from an outside and generate the scan control signal SCS, the emission control signal ECS, and a data control signal DCS. In addition, the timing controller 140 may generate a data signal Vdata based on the input image data IDATA.

For example, the timing controller 140 may convert the input image data IDATA of an RGB format into image data of a format that matches a pixel arrangement in the display unit 110, and generate the data signal Vdata corresponding to the converted image data. At this time, the timing controller 140 may convert an input grayscale value included in the converted image data into the data signal Vdata using a gamma lookup table GLUT.

The data driver 130 may provide the data signal Vdata to the display unit 110, based on the data control signal DCS Here, the data control signal DCS may be a signal that controls an operation of the data driver 130, and may include a load signal (or a data enable signal) that indicates an output of a valid data signal, and the like.

For example, the data driver 130 may include a shift register, a latch, a decoder, an output buffer, and the like, and the data driver 130 may sequentially provide or temporarily store the data signal Vdata to or in the shift register and the latch based on the data control signal DCS, and output the data signal corresponding to the data signal Vdata to the data line through the decoder.

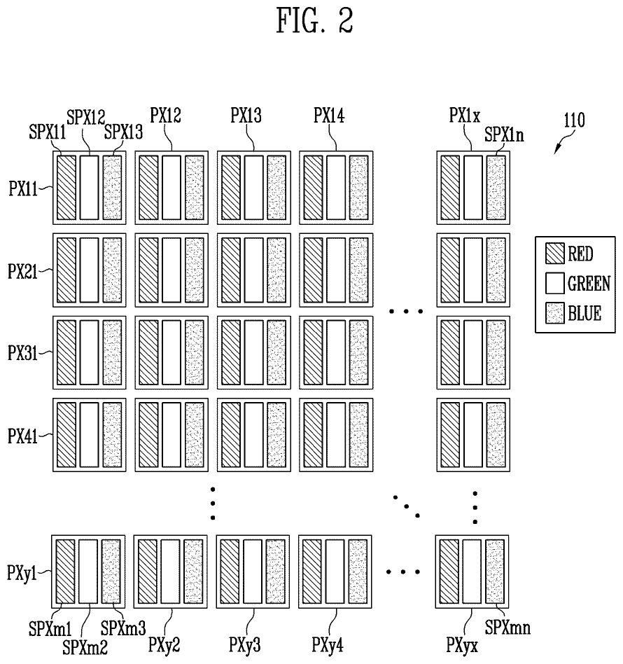

FIG. 2 is a diagram illustrating a disposition of sub-pixels according to an embodiment.

Referring to FIG. 2, pixels disposed in the display unit 110 and sub-pixels disposed in each of the pixels are shown. FIG. 2 shows a structure in which one pixel includes three sub-pixels. The respective three sub-pixels included in one pixel may output light of different colors. For example, each of the three sub-pixels included in one pixel may output light of one of red, green, and blue. For example, a pixel PX11 may include a sub-pixel SPX11 that outputs red light, a sub-pixel SPX12 that outputs green light, and a sub-pixel SPX13 that outputs blue light.

Each pixel row of the display unit 110 includes x pixels (x is a positive integer), and each pixel column includes y pixels (y is a positive integer). For example, a first pixel row of the display unit includes x pixels PX11 to PX1x, and a first pixel column of the display unit 110 includes y pixels PX11 to PXy1.

In addition, each sub-pixel row of the display unit 110 includes n sub-pixels, and each sub-pixel column includes m sub-pixels. For example, a first sub-pixel row of the display unit includes n sub-pixels SPX11 to SPX1n, and a first sub-pixel column of the display unit 110 includes m sub-pixels SPX11 to SPXm1. In the embodiment of FIG. 2, n may have a value of 3x, and values of m and y may be the same.

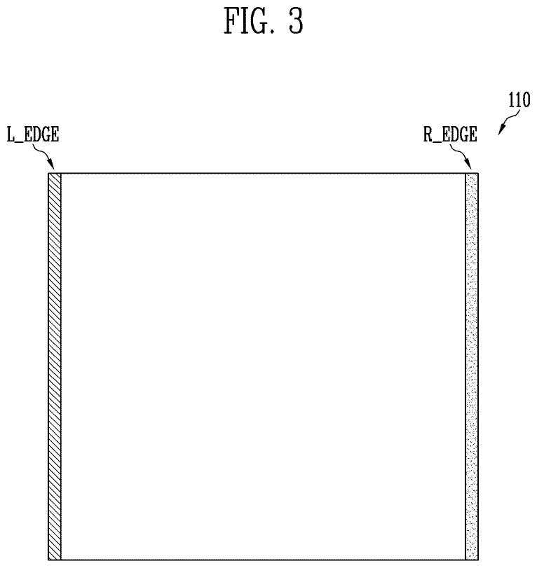

FIG. 3 is a diagram illustrating a problem in which a specific color is visible in an edge area of a display panel when the sub-pixels are arranged according to a way of FIG. 2. Hereinafter, the disclosure is described with reference to FIGS. 2 and 3 together.

Referring to the pixel and sub-pixel disposition of the display unit 110 shown in FIG. 2, the sub-pixels are disposed in a stripe format in each pixel. That is, three sub-pixels are disposed in a row direction in a long stripe form. Therefore, sub-pixels SPX11, SPX21, . . . , and SPXm1 that output red light are disposed at a left edge of the display unit 110 (i.e., the display panel). Meanwhile, sub-pixels SPX1n, SPX2n, . . . , and SPXmn that output blue light are disposed at a right edge of the display panel.

Accordingly, as shown in FIG. 3, light output from the sub-pixels SPX11, SPX21, . . . , and SPXm1 may be visible in a line form of a red in a left edge area L_EDGE of the display unit 110. Meanwhile, light output from the sub-pixels SPX1n, SPX2n, . . . , and SPXmn may be visible in a line form of blue in a right edge area R_EDGE of the display unit 110.

In contrast, sub-pixels SPX11, SPX12, SPX13, . . . , and SPX1n that output red, green, and blue light are evenly disposed at an upper edge of the display unit 110 (i.e., the display panel). In addition, sub-pixels SPXm1, SPXm2, SPXm3, . . . , and SPXmn that output red, green, and blue light are evenly disposed at a lower edge of the display panel. Therefore, a line of a specific color is not visible at an upper end or a lower end of the display unit 110. Hereinafter, sub-pixels that output red, green, and blue light are referred to as a red sub-pixel, a green sub-pixel, and a blue sub-pixel, respectively.

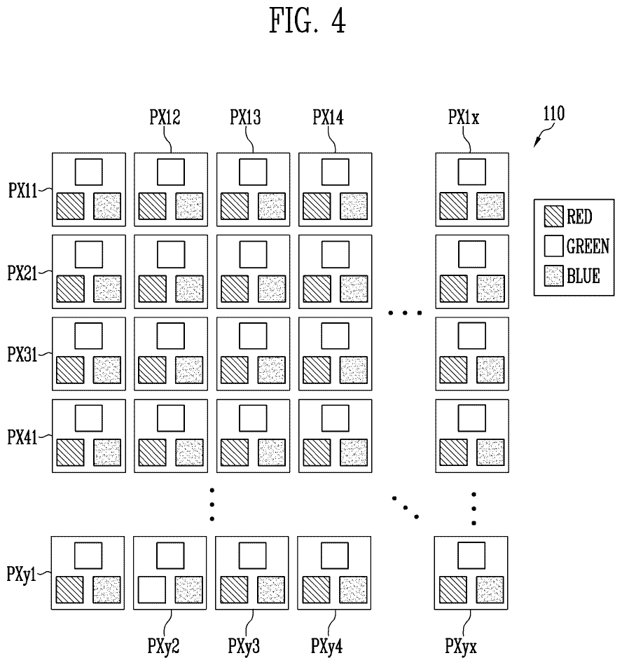

FIG. 4 is a diagram illustrating a disposition of sub-pixels according to another embodiment. Referring to FIG. 4, a disposition form of the sub-pixels included in one pixel is different from that of the pixel of FIG. 2. That is, in the embodiment of FIG. 4, the green sub-pixel may be disposed at an upper center of one pixel area, the red sub-pixel may be disposed at a lower left, and the blue sub-pixel may be disposed at a lower right. As shown in FIGS. 2 and 4, a disposition of the sub-pixels included in one pixel may be variously determined according to need. Meanwhile, the number of sub-pixels included in one pixel may also be variously determined. In the embodiment of FIGS. 2 and 4, one pixel includes three sub-pixels that output different colors, but the disclosure is not limited thereto.

Exemplarily, an embodiment in which one pixel includes four sub-pixels is also applicable to the disclosure. In this case, one sub-pixel that outputs red light, two sub-pixels that output green light, and one sub-pixel that outputs blue light may be included in one pixel. However, for convenience of discussion, in this specification, the disclosure is described based on an embodiment in which one pixel includes three sub-pixels that output light of different colors.

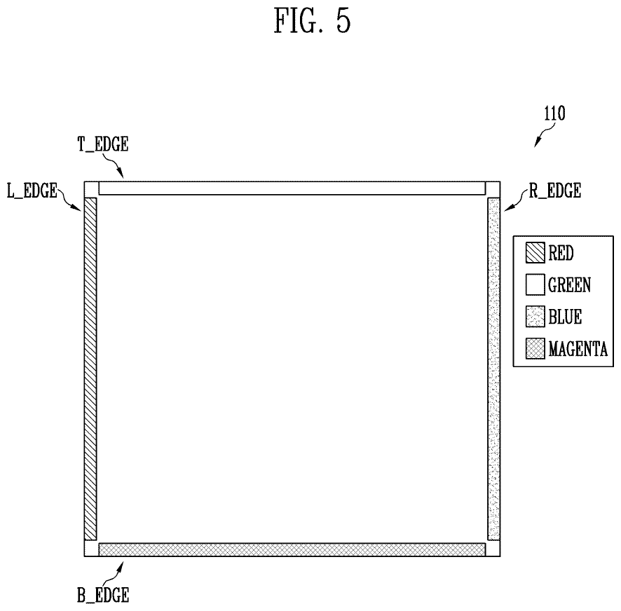

FIG. 5 is a diagram illustrating a problem in which a specific color is visible in an edge area of a display panel when the sub-pixel is disposed according to the method of FIG. 4. Hereinafter, the disclosure is described with reference to FIGS. 4 and 5 together.

Referring to the pixel and sub-pixel disposition of the display unit 110 shown in FIG. 2, the green sub-pixel is disposed at an upper center in each pixel, the red sub-pixel is disposed at a lower left, and the blue sub-pixel is disposed at a lower right. Therefore, the sub-pixels that output the red light are disposed at a left edge of the display unit 110 (i.e., the display panel), and the sub-pixels that output the blue light are disposed at a right edge of the display panel. Accordingly, as shown in FIG. 5, light output from the sub-pixels may be visible in a line form of a red in the left edge area L_EDGE of the display unit 110. Meanwhile, light output from the sub-pixels may be visible in a line form of blue in the right edge area R_EDGE of the display unit 110.

Meanwhile, the sub-pixels that output the green light are disposed at an upper edge of the display unit 110 (i.e., the display panel). Accordingly, as shown in FIG. 5, light output from the sub-pixels may be visible in a line form of green in the upper edge area T_EDGE of the display unit 110.

In addition, the sub-pixels that output the red and blue light are disposed at a lower edge of the display panel. Accordingly, as shown in FIG. 5, light output from the sub-pixels may be visible in a line form of magenta in the lower edge area B_EDGE of the display unit 110.

As described with reference to FIGS. 2 to 5, according to a disposition of the sub-pixels in the pixel, a problem in which a specific color is visible in a line form in an edge area of the display panel, that is, the display unit 110 may occur.

According to a display device according to an embodiment of the disclosure, by converting data corresponding to sub-pixels belonging to the edge area, a problem in which of a specific color is visible in a line form in the edge area may be effectively reduced. In particular, a sub-pixel displaying a conspicuous color as explained above (hereinafter referred to as a “visible sub-pixel”) and a sub-pixel displaying an inconspicuous color as explained above (hereinafter referred to as an “invisible sub-pixel”) are distinguished from each other, and the visible sub-pixel and the invisible sub-pixel are caused to operate differently. The visible sub-pixel is the outermost sub-pixel among the sub-pixels included in the pixels disposed in the edge area, and the visible sub-pixel is not the outermost sub-pixel among the sub-pixels included in the pixels disposed in the edge area.

Specifically, a plurality of image frames are grouped into a frame group, and the visible sub-pixels are operated and the invisible sub-pixels are not operated in a first frame in the frame group. Meanwhile, in a second frame in the frame group, the invisible sub-pixels are operated and the visible sub-pixels are not operated. Through this, a problem in which a specific color is visible in a line form in the edge area may be effectively reduced.

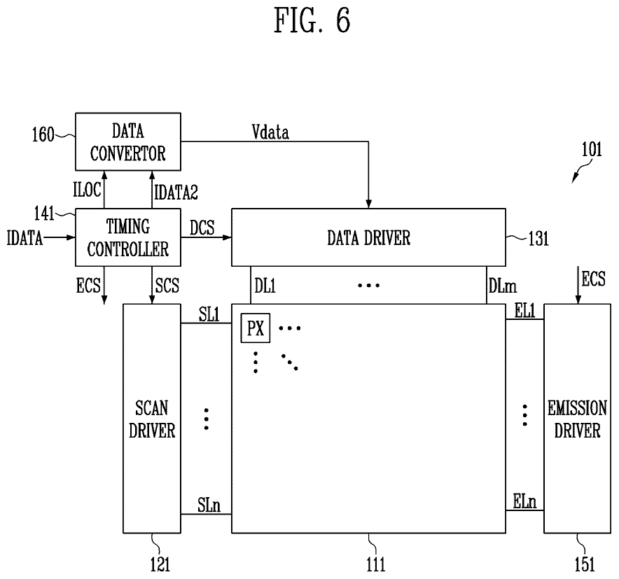

FIG. 6 is a block diagram illustrating a display device according to another embodiment of the disclosure.

Referring to FIG. 6, the display device 101 may include a display unit 111 (or a display panel), a scan driver 121, a data driver 131, a timing controller 141, and an emission driver 151. Meanwhile, the display device 101 of FIG. 6 may further include a data converter 160. The display unit 111 (or the display panel), the scan driver 121, the data driver 131, and the emission driver 151 of FIG. 6 may operate in substantially the same method as the display unit 110 (or the display panel), the scan driver 120, the data driver 130, and the emission driver 150, respectively. Therefore, an overlapping description of these components is omitted.

The timing controller 141 included in the display device 101 of FIG. 6 may convert input image data IDATA of an RGB format to generate second image data IDATA2 of a format that matches a pixel arrangement in the display unit 111, and transmits the generated image data IDATA2 to the data converter 160. Meanwhile, the timing controller 141 may transmit position data ILOC including information on a position of the second image data IDATA2 to the data converter 160. In an embodiment, the position data ILOC may be data indicating whether the second image data IDATA2 belongs to a specific edge area of the display unit 111.

The data converter 160 may convert the second image data IDATA2 based on the received position data ILOC. Meanwhile, the data converter 160 may convert an input grayscale value included in the converted image data into the data signal Vdata using the gamma lookup table GLUT, and transmit the data signal Vdata to the data driver 131.

In the embodiment of FIG. 6, the data converter 160 is shown as being configured separately from the timing controller 141. However, the disclosure is not limited thereto, and the data converter 160 may be configured to be integrated into the timing controller 141. As another example, the data converter 160 may exist outside the display device 101, and in this case, the image data converted from the data converter 160 may be input to the timing controller of the display device.

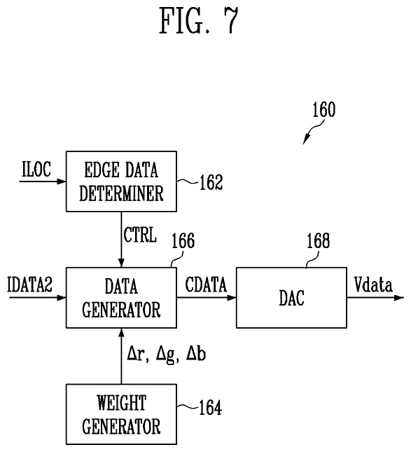

FIG. 7 is a block diagram illustrating an embodiment of the data converter of FIG. 6.

Referring to FIG. 7, the data converter 160 may include an edge data determiner 162, a weight generator 164, a data generator 166, and a digital-to-analog converter 168.

The edge data determiner 162 receives the position data ILOC from the timing controller 141. As described above, the position data ILOC may be data indicating whether the second image data IDATA2 is for pixels belonging to a specific edge area of the display unit 111. The edge data determiner 162 generates a control signal CTRL for controlling a data generation operation of the data generator 166 based on the position data ILOC.

The weight generator 164 may generate weights corresponding to each of the sub-pixels included in the pixel belonging to the edge area and transmit the weights to the data generator 166. As an example, the weight generator 164 may transmit a red weight Δr, a green weight Δg, and a blue weight Δb to the data generator 166. In an embodiment, the weight generator 164 may be implemented as a memory and may store the red weight Δr, the green weight Δg, and the blue weight Δb.

The data generator 166 generates conversion data CDATA from the second image data IDATA2 based on the control signal CTRL received from the edge data determiner 162 and the weights Δr, Δg, and Δb generated by the weight generator 164. The digital-to-analog converter 168 generates the data signal Vdata from the conversion data CDATA of a digital form.

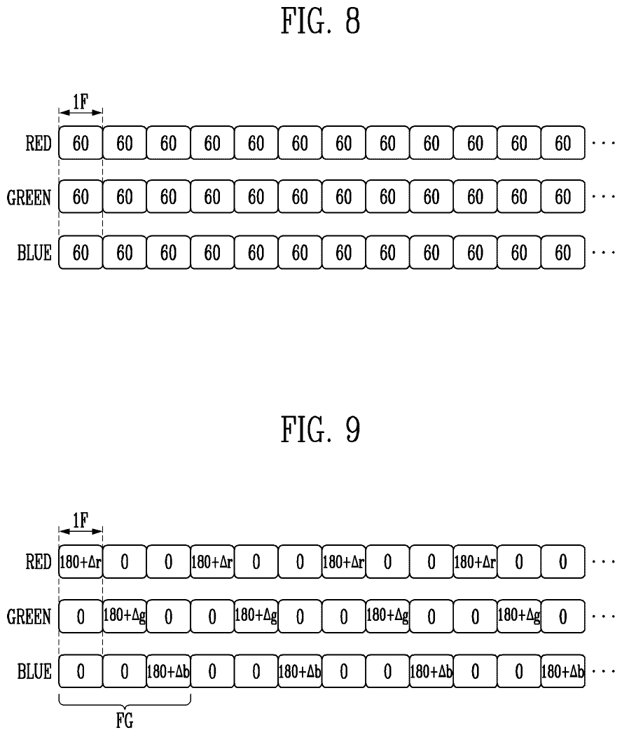

Hereinafter, an operation of the data converter 160 is described in more detail with reference to FIGS. 8 to 11C.

FIG. 8 is a diagram illustrating image data of an edge area input to the data generator. That is, FIG. 8 illustrates the second image data IDATA2 input to the data generator 166. FIG. 9 is a diagram illustrating an embodiment of the conversion data CDATA of the edge area output from the data generator 166.

Referring to FIG. 8, image data of a plurality of frames corresponding to each of the red sub-pixel, the green sub-pixel, and the blue sub-pixel are shown. That is, in an example of FIG. 8, the image data of the edge area input to the data converter 160 may be grayscale data of 60 Gray corresponding to the red sub-pixel, the green sub-pixel, and the blue sub-pixel, respectively. When the image data shown in FIG. 8 is converted into the data signal Vdata and applied to a data line connected to a pixel of the edge area, a problem in which a line of a specific color is visible in the edge area may occur, as described above. Therefore, when it is determined that input data is data of the edge area, the data converter 160 converts the input data as shown in FIG. 9.

Referring to FIG. 9, three frames configure one frame group FG. In one frame group FG, sub-pixels belonging to the pixel of the edge area each operate only in a certain frame and do not operate in all frames.

Specifically, among the sub-pixels included in the pixel of the edge area in a first frame in the frame group FG, only the red sub-pixel outputs light, and the green and blue sub-pixels do not output light. Meanwhile, among the sub-pixels included in the pixel of the edge area in a second frame in the frame group FG, only the green sub-pixel outputs light, and the red and blue sub-pixels do not output light. Lastly, among the sub-pixels included in the pixel of the edge area in a third frame in the frame group FG, only the blue sub-pixel outputs light, and the red and green sub-pixels do not output light.

In addition, in order to cause pixels of the edge area driven partially in a certain frame in one frame group FG to emit light of a luminance the same as the overall luminance of pixels emitting light in all frames of one frame group, the luminance of light emitted by each of the sub-pixels at the edge area is required to be greater than the overall luminance. Therefore, referring to FIG. 9, the red sub-pixel may generate light corresponding to a grayscale of 180+Δr when driven. Specifically, the red sub-pixel may generate light corresponding to a value obtained by adding the red weight Δr to a grayscale corresponding to 3 times 60 Gray in the first frame of the frame group. Meanwhile, the red sub-pixel may not generate light in each of the second and third frames of the frame group FG.

Meanwhile, the green sub-pixel may generate light corresponding to a value obtained by adding the green weight Δg to a grayscale corresponding to 3 times 60 Gray in the second frame of the frame group FG. Meanwhile, the green sub-pixel may not generate light in each of the first and third frames of the frame group FG.

In addition, the blue sub-pixel may generate light corresponding to a value obtained by adding the blue weight Δb to a grayscale corresponding to 3 times 60 Gray in the third frame of the frame group FG. Meanwhile, the blue sub-pixel may not generate light in each of the first and second frames of the frame group FG.

In the method described above, the sub-pixels included in the pixel corresponding to the edge area may generate light only in a certain frame among the frames belonging to the frame group FG and may not generate light in the other frames. Through this, a luminance of the pixel may be maintained while preventing a phenomenon in which a specific color is visible in the edge area.

The data generator 166 of the data converter 160 may convert the second image data in the form shown in FIG. 8 and generate the conversion data CDATA in the form shown in FIG. 9.

The red weight Δr, the green weight Δg, and the blue weight Δb may be variously determined according to need. In an embodiment, the red weight Δr, the green weight Δg, and the blue weight Δb may be predetermined to reduce the visibility of the specific color in the edge area.

For example, the light generated from the red pixels is easily visible in the left edge area L_EDGE of FIG. 3. Therefore, with respect to pixels corresponding to the most left side of the display panel 110, the red weight Δr may have a negative value, and the green weight Δg and the blue weight Δb may each have a positive value. In this case, in the conversion data CDATA of FIG. 9, the red sub-pixel may generate light corresponding to a grayscale less than 180 Gray in the first frame of the frame group. Meanwhile, the green sub-pixel may generate light corresponding to a grayscale greater than 180 Gray in the second frame of the frame group. In addition, the blue sub-pixel may generate light corresponding to a grayscale greater than 180 Gray in the third frame of the frame group.

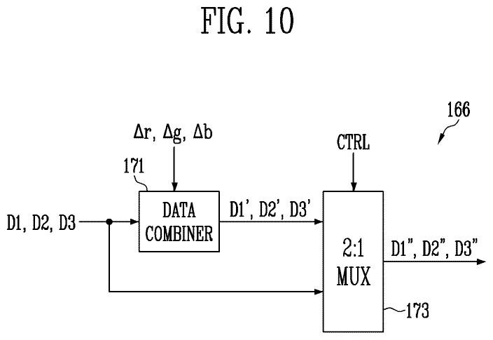

An embodiment of the data generator 166 is described with reference to FIG. 10.

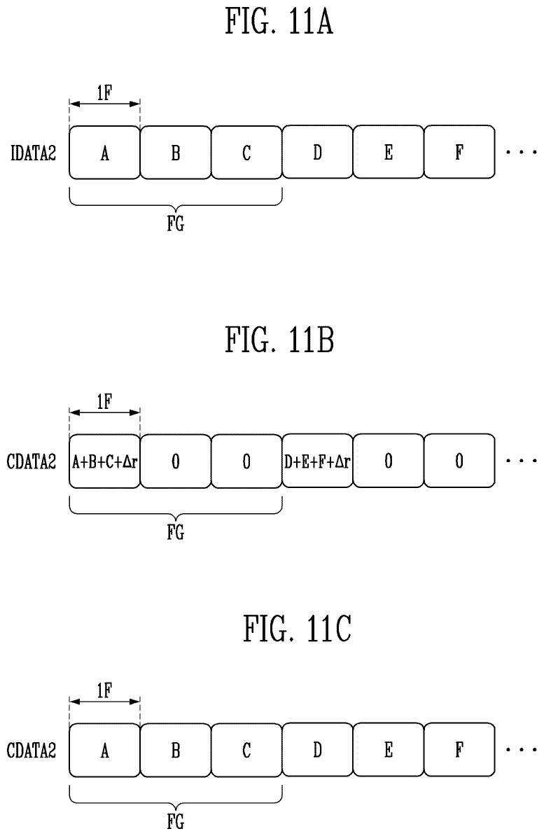

FIG. 10 is a block diagram illustrating an embodiment of the data generator of FIG. 7. FIGS. 11A, 11B, and 11C are diagrams illustrating an operation of the data generator of FIG. 10.

Referring to FIG. 10, the data generator 166 may include a data combiner 171 and a multiplexer 173. In FIG. 10, the multiplexer 173 may be a 2:1 multiplexer.

The data combiner 171 may receive first frame data D1, second frame data D2, and third frame data D3 corresponding to three frames belonging to the frame group FG, respectively. The first to third frame data D1, D2, and D3 may be included in the second image data IDATA2.

The data combiner 171 also receives the red weight Δr, the green weight Δg, and the blue weight Δb. When the first to third frame data D1, D2, and D3 are data of the red sub-pixel, the data combiner 171 may generate first to third frame data D1′, D2′, and D3′ converted using the red weight Δr.

As an example, the converted first frame data D1′ may be generated using Equation 1 below:

$$D {1}^{′} = D 1 + D 2 + D 3 + Δ r \qquad [ Equation 1 ]$$

Meanwhile, each of the converted second and third frame data D2′ and D3′ may have a value of 0. The converted first to third frame data D1′, D2′, and D3′ may be provided as a first input of the multiplexer 173.

In addition, the first to third frame data D1, D2, and D3 may be provided as a second input of the multiplexer 173. The multiplexer 173 may output selectively the converted first to third frame data D1′, D2′, and D3′ or the first to third frame data D1, D2, and D3 as first to third output frame data D1″, D2″, and D3″, based on the control signal CTRL. The first to third output frame data D1″, D2″, and D3″ may be included in the conversion data CDATA.

As described above, the control signal CTRL may be a signal provided from the edge data determiner 162, and may be a signal indicating whether the second image data IDATA, specifically the first to third frame data D1, D2, and D3 belong to the edge area.

When the first to third frame data D1, D2, and D3 are data belonging to the edge area, the multiplexer 173 may output the converted first to third frame data D1′, D2′, and D3′ as the first to third output frame data D1″, D2″, and D3″. On the other hand, when the first to third frame data D1, D2, and D3 are data that do not belong to the edge area, the multiplexer 173 may output the first to third frame data D1, D2, and D3 as the first to third output frame data D1″, D2″, and D3″.

Referring to FIG. 11A, the second image data IDATA2 input to the data generator 166 is shown. The second image data IDATA2 may include frame data having a grayscale such as A, B, C, D, E, and F.

FIG. 11B shows frame data included in the conversion data CDATA output by the data generator 166 when the second image data IDATA2 is data of the sub-pixel belonging to the edge area. When the second input data IDATA2 is data corresponding to the red sub-pixel, the data combiner 171 may sum a grayscale value of the frame data included in one frame group using [Equation 1] described above, and generate a value obtained by adding the red weight Δr to a result of the sum as frame data corresponding to the first frame in the frame group. Meanwhile, the data combiner 171 may calculate a value of 0 as the second and third frame data in the frame group FG. Accordingly, as shown in FIG. 11B, a value of the first frame data of a first frame group FG becomes “A+B+C+Ar”, and a value of the second and third frame data becomes 0. In addition, a value of the first frame data of a second frame group FG becomes “D+E+F+Ar”, and a value of the second and third frame data becomes 0.

FIG. 11C shows frame data included in the conversion data CDATA output by the data generator 166 when the image data IDATA2 is data of a sub-pixel belonging to a normal area other than the edge area. In this case, the data generator 166 may output the second image data shown in FIG. 11A as the conversion data CDATA as it is.

As described above, according to a display device according to an embodiment of the disclosure, by converting the data corresponding to the sub-pixels belonging to the edge area, a problem in which a specific color is visible in a line form in the edge area may be effectively reduced. In particular, the visible sub-pixel and the invisible sub-pixel are distinguished, and the visible sub-pixel and the invisible sub-pixel are caused to operate differently. Specifically, a plurality of image frames are divided into the frame group, and the visible sub-pixels are operated and the invisible sub-pixels are not operated in the first frame in the frame group. Meanwhile, the invisible sub-pixels are operated and the visible sub-pixels are not operated in the second frame in the frame group. Through this, a problem in which a specific color is visible in a line form in the edge area may be effectively reduced.

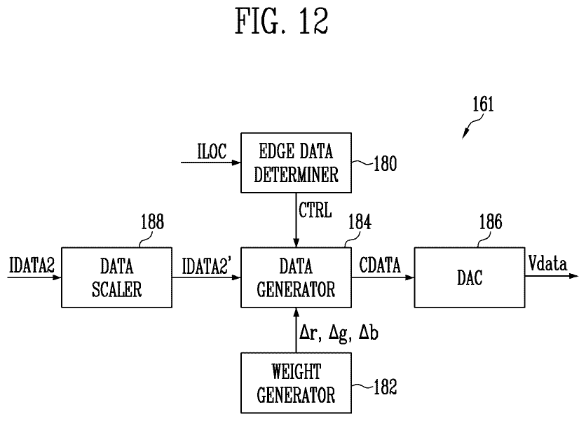

FIG. 12 is a block diagram illustrating another embodiment of the data converter of FIG. 6. Referring to FIG. 12, the data converter 161 may include an edge data determiner 180, a weight generator 182, a data generator 184, and a digital-to-analog converter 186. The edge data determiner 180, the weight generator 182, the data generator 184, and the digital-to-analog converter 186 shown in FIG. 12 may be substantially the same components as the edge data determiner 162, the weight generator 164, the data generator 166, and the digital-to-analog converter 168 described with reference to FIG. 7, respectively. Therefore, an overlapping description of these components is omitted.

In FIG. 12, the data converter 161 may further include a data scaler 188. The data scaler 188 may generate scaled second image data IDATA2′ from the second image data IDATA2, based on a predetermined scaling ratio ASR.

As described above, the data generator 184 may sum a plurality of frame data belonging to one frame group and output a value obtained by the sum as one frame data with respect to the sub-pixels belonging to the edge area. At this time, a grayscale range of output frame data is limited. For example, when a grayscale range of image data displayed by the display device 100 is 256 levels from 0 to 255, the grayscale value of the output frame data may not exceed 255. Therefore, when a sum of a grayscale value of three frame data belonging to the frame group exceeds 255, the grayscale value of the output frame data may be saturated. This causes a problem that image quality is effectively reduced when displaying image data of a high grayscale.

In order to solve this problem, the data scaler 188 may perform downscaling of the second image data IDATA2 according to a preset condition, thereby preventing a high grayscale area of the conversion data CDATA output from the data generator 184 from being saturated.

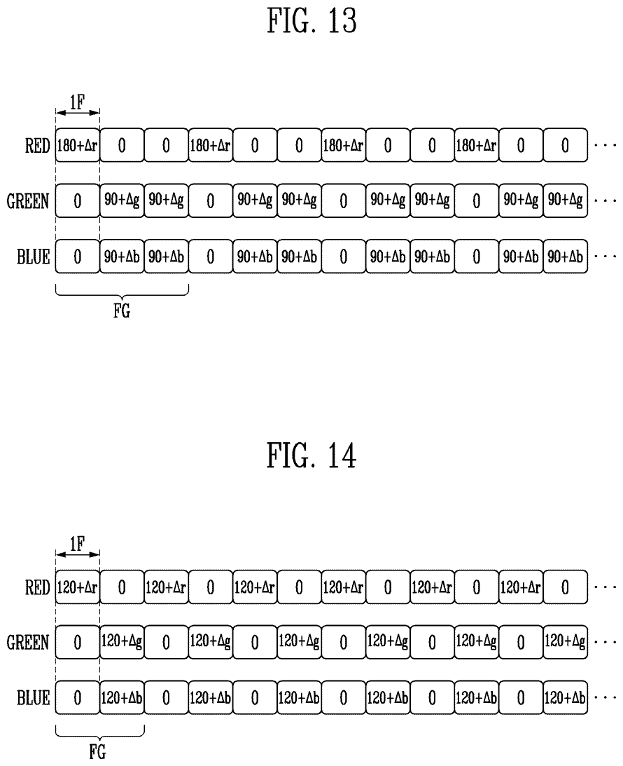

FIG. 13 is a diagram illustrating another embodiment of the conversion data of the edge area output from the data converter.

Referring to FIGS. 9 and 11B, an embodiment in which one frame group FG includes three frames and only one sub-pixel outputs light in one frame in one frame group FG is shown, but the disclosure is not limited thereto. Referring to FIG. 13, three frames configure one frame group FG. Meanwhile, in one frame group FG, the sub-pixels belonging to the pixel of the edge area operate only in one or two frames and do not operate in all frames. This is the same as the embodiment shown in FIGS. 9 and 11B.

Meanwhile, according to an embodiment shown in FIG. 13, among the sub-pixels included in the pixel of the edge area in the first frame in the frame group FG, only the red sub-pixel outputs light, and the green and blue sub-pixels do not output light. Meanwhile, among the sub-pixels included in the pixel of the edge area in each of the second and third frames in the frame group FG, the green and blue sub-pixels output light, and the red sub-pixel does not output light. That is, only the red sub-pixel, which is the visible sub-pixel, may be driven in one frame in the frame group FG, and the green and blue sub-pixels, which are the invisible sub-pixels, may be driven in remaining two frames.

In the embodiment of FIG. 13, frame data for driving the red sub-pixel in the first frame in the frame group FG may be calculated using [Equation 1] described above. Frame data for driving the red sub-pixel in each of the second and third frames in the frame group FG becomes 0.

Meanwhile, in the embodiment of FIG. 13, frame data for driving the green sub-pixel in each of the second and third frames may be calculated using [Equation 2] below:

$$D {2}^{′} = \frac{D 1 + D 2 + D 3}{2} + Δ g \qquad [ Equation 2 ]$$

Frame data for driving the blue sub-pixel in each of the second and third frames may also be calculated in a method similar to Equation 2 above.

In the method described above, the sub-pixels included in the pixel corresponding to the edge area may generate light only in a certain frame belonging to the frame group FG and may not generate light in the other frames. Through this, the luminance of the pixel may be maintained while preventing a phenomenon in which a specific color is visible in the edge area.

FIG. 14 is a diagram illustrating still another embodiment of the conversion data of the edge area output from the data converter.

Referring to FIGS. 9 and 11B, an embodiment in which one frame group FG includes three frames and only one sub-pixel outputs light in one frame in one frame group FG is shown, but the disclosure is not limited thereto. Referring to FIG. 14, two frames configure one frame group FG. Meanwhile, in one frame group FG, the sub-pixels belonging to the pixel of the edge area operate only in a certain frame and do not operate in another frame in the one frame group FG.

Specifically, referring to FIG. 14, among the sub-pixels included in the pixel of the edge area in the first frame in the frame group, only the red sub-pixel outputs light, and the green and blue sub-pixels do not output light. Meanwhile, among the sub-pixels included in the pixel of the edge area in the second frame in the frame group, the green and blue sub-pixels output light, and the red sub-pixel does not output light. That is, only the red sub-pixel, which is the visible sub-pixel, may be driven in one frame in the frame group, and the green and blue sub-pixels, which are the invisible sub-pixels, may be driven in remaining one frame.

In an embodiment of FIG. 14, when the second input data IDATA2 is data corresponding to the red sub-pixel, the data combiner 171 may sum a grayscale value of the frame data included in one frame group, and generate a value obtained by adding the red weight Δr to a result of the sum as frame data corresponding to the first frame in the frame group. That is, the frame data for driving the red sub-pixel in the first frame in the frame group may be calculated using [Equation 3] below:

$$D {1}^{′} = D 1 + D 2 + Δ r \qquad [ Equation 3 ]$$

The frame data for driving the green and blue sub-pixels in the second frame may also be calculated in a method similar to this.

In the method described above, the sub-pixels included in the pixel corresponding to the edge area may generate light only in a certain frame belonging to the frame group FG and may not generate light in the other frames belonging to the frame group FG. Through this, the luminance of the pixel may be maintained while preventing a phenomenon in which a specific color is visible in the edge area.

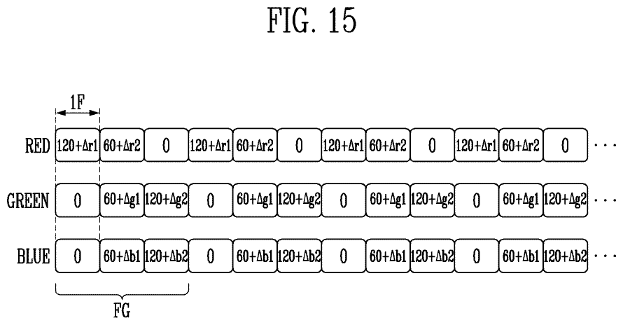

FIG. 15 is a diagram illustrating still another embodiment of the conversion data of the edge area output from the data converter.

Referring to FIG. 15, three frames configure one frame group FG. Meanwhile, in one frame group FG, the sub-pixels belonging to the pixel of the edge area operate only in certain frames and do not operate in all frames belonging to the frame group FG.

Specifically, among the sub-pixels included in the pixel of the edge area in the first frame in the frame group, only the red sub-pixel outputs light, and the green and blue sub-pixels do not output light. Meanwhile, among the sub-pixels included in the pixel of the edge area in the second frame in the frame group, all of the red, green, and blue sub-pixels may output light. In addition, among the sub-pixels included in the pixel of the edge area in the third frame in the frame group, only the green and blue sub-pixels may output light, and the red sub-pixels may not output light.

In the embodiment of FIG. 15, when the second input data IDATA2 is data corresponding to the red sub-pixel, the data combiner 171 may generate frame data corresponding to the first frame in the frame group using Equation 4 below:

$$D {1}^{′} = \frac{2}{3} \cdot ( D 1 + D 2 + D 3 ) + Δ r 1 \qquad [ Equation 4 ]$$

In addition, the data combiner 171 may generate frame data corresponding to the second frame in the frame group using Equation 5 below:

$$D {2}^{′} = \frac{1}{3} \cdot ( D 1 + D 2 + D 3 ) + Δ r 2 \qquad [ Equation 5 ]$$

In Equations 4 and 5, r1 may represent a first red weight and r2 may represent a second red weight. The first red weight r1 and the second red weight r2 may have the same value or different values.

The frame data for driving the green and blue sub-pixels in the second frame may also be calculated in a method similar to the method of calculating the frame data for driving the red sub-pixel in the second frame. Meanwhile, the frame data for driving the green and blue sub-pixels in the third frame may also be calculated in a method similar to the method of calculating the frame data for driving the red sub-pixel in the first frame.

As described above, the sub-pixels included in the pixel corresponding to the edge area may generate light only in a certain frame belonging to the frame group FG and may not generate light in the other frames belonging to the frame group FG. Through this, the luminance of the pixel may be maintained while preventing a phenomenon in which a specific color is visible in the edge area. As used in connection with various embodiments of the disclosure, each of the edge data determiner 162, the weight generator 164, the data generator 166, the data combiner 171, and the data scaler 188 may be implemented in hardware, software, or firmware, for example, implemented in a form of an application-specific integrated circuit (ASIC).

Although the technical spirit of the disclosure has been described in detail in accordance with the above-described embodiments, it should be noted that the above-described embodiments are for the purpose of description and not of limitation. In addition, those skilled in the art may understand that various modifications are possible within the scope of the technical spirit of the disclosure.

What is claimed is:

1. A display device comprising:
a display panel including a plurality of pixels;
a scan driver configured to provide a scan signal to the display panel;
a data driver configured to provide a data signal corresponding to each of the plurality of pixels to the display panel;
a timing controller configured to control driving of the scan driver and the data driver; and
a data converter configured to convert image data output from the timing controller to generate the data signal,
wherein the data converter is configured to generate the data signal to cause a first sub-pixel, among sub-pixels included in pixels disposed in an edge area of the display panel, to output light in a first frame in a frame group including a plurality of frames and not to output light in a second frame in the frame group.

2. The display device according to claim 1, wherein the data converter is configured to generate the data signal to cause a second sub-pixel, among the sub-pixels included in the pixels disposed in the edge area, not to output light in the first frame.

3. The display device according to claim 2, wherein the data converter is configured to generate the data signal to cause the second sub-pixel to output light in the second frame.

4. The display device according to claim 3, wherein the first sub-pixel is an outermost sub-pixel among the sub-pixels included in the pixels disposed in the edge area, and the second sub-pixel is not an outermost sub-pixel among the sub-pixels included in the pixels disposed in the edge area.

5. The display device according to claim 3, wherein the data converter is configured to generate a data signal of the first sub-pixel corresponding to the first frame based on a sum of frame data of the first sub-pixel corresponding to each of frames included in the frame group.

6. The display device according to claim 5, wherein the data converter is configured to generate the data signal of the first sub-pixel by adding a first weight corresponding to the first sub-pixel to the sum of the frame data of the first sub-pixel.

7. The display device according to claim 6, wherein the first weight is a real number less than 0.

8. The display device according to claim 5, wherein the data converter is configured to generate a data signal of the second sub-pixel corresponding to the second frame based on a sum of frame data of the second sub-pixel corresponding to each of frames included in the frame group.

9. The display device according to claim 8, wherein the data converter is configured to generate the data signal of the second sub-pixel by adding a second weight corresponding to the second sub-pixel to the sum of the frame data of the second sub-pixel.

10. The display device according to claim 9, wherein the second weight is a real number greater than 0.

11. The data device according to claim 3, wherein the data converter is configured to generate the data signal to cause a third sub-pixel, among the sub-pixels included in the pixels disposed in the edge area, to output light in a third frame in the frame group.

12. The display device according to claim 11, wherein the data converter is configured to generate the data signal to cause the third sub-pixel not to output light in the first frame and in the second frame, and the first and second sub-pixels not to output light in the third frame.

13. The display device according to claim 11, wherein the data converter is configured to generate the data signal to cause the third sub-pixel not to output light in the first frame, the third sub-pixel to output light in the second frame, the first sub-pixel not to output light, and the second sub-pixel to output light in the third frame.

14. The display device according to claim 11, wherein the data converter is configured to generate the data signal to cause the third sub-pixel not to output light in the first frame, the first and third sub-pixels to output light in the second frame, and the second sub-pixel to output light in the third frame.

15. The display device according to claim 3, wherein the frame group includes two frames, and
the data converter is configured to generate the data signal to cause a third sub-pixel, which is not an outermost sub-pixel among the sub-pixels included in the pixels disposed in the edge area, to output light in the second frame and not to output light in the first frame.

16. The display device according to claim 3, wherein the data converter comprises:
an edge data determiner configured to determine whether the image data corresponds to the edge area and generate a control signal;
a weight generator configured to generate a weight used to convert the image data; and
a data generator configured to selectively convert the image data based on the weight and the control signal and generate conversion data.

17. The display device according to claim 16, wherein the data converter further comprises a digital-to-analog converter configured to convert the conversion data into the data signal.

18. The display device according to claim 16, wherein the data converter further comprises a data scaler configured to downscale the image data and provide downscaled image data to the data generator.

19. A display device comprising:
a display panel including a plurality of pixels;
a scan driver configured to provide a scan signal to the display panel;
a data driver configured to provide a data signal corresponding to each of the plurality of pixels to the display panel; and
a timing controller configured to control driving of the scan driver and the data driver, and convert image data to generate the data signal,
wherein the timing controller is configured to generate the data signal to cause a first sub-pixel, among sub-pixels included in pixels disposed in an edge area of the display panel, to output light in a first frame in a frame group including a plurality of frames and not to output light in a second frame in the frame group.

20. The display device according to claim 19, wherein the timing controller is configured to generate the data signal to cause a second sub-pixel, among the sub-pixels included in the pixels disposed in the edge area, not to output light in the first frame and the second sub-pixel to output light in the second frame.
